(19) United States
(12) Patent Application Publication
(10) Pub. No.: US 2014/0260525 A1
(43) Pub. Date: Sep. 18, 2014

(54) APPARATUS, METHODS AND SYSTEMS FOR MEASUREMENT OF CHIP LOSS DURING ASPHALT SURFACE TREATMENT CONSTRUCTION AND DESIGN

(71) Applicant: InstroTek, Inc., Raleigh, NC (US)

(72) Inventors: Peter D. Muse, Durham, NC (US); Lawrence H. James, Raleigh, NC (US); Ali Regimand, Raleigh, NC (US)

(73) Assignee: InstroTek, Inc., Raleigh, NC (US)

(21) Appl. No.: 14/213,528

(22) Filed: Mar. 14, 2014

Related U.S. Application Data
(60) Provisional application No. 61/790,399, filed on Mar. 15, 2013.

(51) Int. Cl. G01N 19/00

(52) U.S. Cl. CPC G01N 19/00
USPC 73/8

(57) ABSTRACT

A post-road surface maintenance field test device includes a frame, a plurality of wheels connected to the frame, a rotatable brush held at least partially by or within the frame, a drive mechanism configured to rotate the brush, and a collection member. The collection member is held at least partially by or within the frame and resides adjacent the rotatable brush. In operation, as the device is conveyed over a road surface, the drive mechanism rotates the brush and the brush engages loose aggregates and/or aggregates that are weakly bound to a bonding medium and urges the engaged aggregates into the collection member.

### RELATED APPLICATIONS

This application claims priority from U.S. Provisional Application No. 61/790,399, filed Mar. 15, 2013, the disclosure of which is hereby incorporated herein in its entirety.

### BACKGROUND

In many cases for maintenance of road pavements, the expense of repaving large sections of a road or the entire road outweighs the benefit. In these cases, asphalt surface treatment (AST) methods, such as chip seal, slurry seal, fog seal, and broom seal, may be used. These surface treatments involve combining emulsions with aggregates to provide a protective coating for road surfaces. Chip seal treatment uses a bonding medium known as “tack coat” (e.g., bitumen or emulsion) that is sprayed on or otherwise applied to an existing road surface in need of repair and an aggregate layer on top of the tack coat. The aggregate layer is spread and then rolled with a paving roller to press the aggregate into the tack coat. After the rolling of the aggregate, a bond time allows for the aggregate to bond with the tack coat. After the bond time, a brush roller sweeps most of the loose aggregate to the side of the road and traffic is allowed back on the road. Other treatments such as fog seals and broom seals include a tack coat on top of the chip seal to prevent aggregate loss. For all methods, it is important to know when an asphalt surface treatment is well bonded and the road can be opened to traffic.

The cure time for the tack coat is traditionally based on an assumption from previous use or by monitoring the change in color, from brown during laydown to black indicating the liquid emulsion has reached a stable state. In practice, the time varies based on road temperature, humidity, and ambient temperature.

There is a need for methods and apparatus for effective field testing of road surfaces that have undergone an asphalt surface treatment.

### SUMMARY

According to a first aspect, embodiments of the invention are directed to a post-road surface maintenance field test device. The device includes a frame; a plurality of wheels connected to the frame; a rotatable brush held at least partially by or within the frame; a drive mechanism configured to rotate the brush; and a collection member held at least partially by or within the frame, the collection member residing adjacent the rotatable brush. In operation, as the device is conveyed over a road surface, the drive mechanism rotates the brush and the brush engages loose aggregates and/or aggregates that are weakly bound to a bonding medium and urges the engaged aggregates into the collection member.

The device may include a speed detection mechanism and at least one indicator and/or alarm to provide audible and/or visual feedback to the user that the device is being conveyed at a proper speed and/or within a proper speed range. The device may include or be in communication with a distance measurement device configured to measure a distance that the device is conveyed over the road surface.

In some embodiments, the device includes a handle connected to the frame, the handle adapted for a user to manually convey the device over the road surface. In some embodiments, the device includes a drive mechanism operatively connected to the wheels to automatically convey the device over the road surface.

The device may include at least one of an ambient temperature sensor to detect an ambient temperature or a road surface temperature sensor to detect a road surface temperature. The device may include a scale integrated with or in communication with the collection member, the scale configured to weigh the aggregate collected in the collection member. In some embodiments, the collection member has an opening facing the brush and a bottom edge that resides closely spaced to or abutting the road surface.

In some embodiments, the device includes a controller and at least one of a display, a memory and a user input device. The controller may be configured to perform at least one of the following: receive from the user input device data including at least one of a cure time, a bond time and a total weight of aggregate applied on the bonding medium; receive from the scale the weight of the aggregate collected; receive from the ambient temperature sensor the detected ambient temperature; receive from the road surface temperature sensor the detected road surface temperature; and receive from the distance measurement device the distance conveyed over the road surface. The controller may be configured to perform at least one of the following: determine the speed at which the device is conveyed based on at least one of the speed detection mechanism and the distance measurement device; and determine the percent loss of aggregate per unit area based on the weight of the aggregate collected and the distance conveyed over the road surface. The controller may be configured to communicate with the display and/or the memory to display on the display and/or store in the memory at least one of the following: cure time, bond time, total weight of aggregate, weight of aggregate collected, ambient temperature, road surface temperature, the distance conveyed over the road surface, the speed at which the device is conveyed and the percent loss of the aggregate per unit area.

In some embodiments, the device includes a receiver configured to receive signals from an external device and/or a remote control, including at least one of the following: a command to start or stop the drive mechanism associated with the wheels and/or the drive mechanism associated with the brush; a command to convey the device over the road surface; and a request for data including at least one of cure time, bond time, total weight of aggregate, weight of aggregate collected, ambient temperature, road surface temperature, the distance conveyed over the road surface, the speed at which the device is conveyed and the percent loss of the aggregate per unit area.

In some embodiments, the device includes a transmitter configured to transmit signals to an external device such that at least one of the following can be displayed and/or storied in data at the external device: cure time, bond time, total weight of aggregate, weight of aggregate collected, ambient temperature, road surface temperature, the distance conveyed over the road surface, the speed at which the device is conveyed and the percent loss of the aggregate per unit area.

According to a second aspect, a method for testing the adequacy of a bond between a bonding medium and an aggregate applied thereon by a maintenance operation on a road surface includes: conveying a device a distance over the road surface; collecting loose and/or weakly bound aggregate in the device as the device is conveyed over the road surface; weighing the aggregate collected in the device; and electronically determining a loss of aggregate based on the weight of the aggregate collected in the device.

In some embodiments, the method includes: electronically measuring the distance that the device is conveyed over the road surface; and electronically determining a percent loss of aggregate per unit area based on the weight of the aggregate collected in the device and the measured distance that the device is conveyed over the road surface.

The device may include a frame, a rotatable brush at least partially held within the frame, and a collection member at least partially held within the frame adjacent the rotatable brush, and wherein the step of collecting loose and/or weakly bound aggregate in the device as the device is conveyed over the road surface comprises: rotating the brush; and urging the aggregate into the collection member using the rotating brush. The device may include a scale integrated with or in communication with the collection member, and the method may include weighing the aggregate collected in the device using the scale. The collection member may be removable from the frame, and the method may include: removing the collection member with the collected aggregate therein; and weighing the collected aggregate with or without the collection member.

The method may include automatically, manually or remotely conveying the device a distance over the road surface. The method may include measuring at least one of a surface temperature and an ambient temperature as the device is conveyed over the road surface.

In some embodiments, the method includes measuring at least one of: a cure time indicating the time between application of the bonding medium on the road surface and application of the aggregate on the bonding medium during the maintenance operation; a total weight of the aggregate applied on the bonding medium; and a bond time indicating a time between application of the aggregate on the bonding medium and a determination that the maintenance operation is deemed to be complete.

In some embodiments, the method includes electronically storing in memory at least one of the distance the device is conveyed over the road surface, the weight of the aggregate collected in the device, the percent loss of aggregate per unit area, the surface temperature, the ambient temperature, the cure time, the total weight of aggregate and the bond time.

In some embodiments, the device includes a transmitter, and the method includes transmitting at least one of the following to at least one external device using the transmitter: the distance the device is conveyed over the road surface, the weight of the aggregate collected in the device, the percent loss of aggregate per unit area, the surface temperature, the ambient temperature, the cure time, the total weight of aggregate and the bond time.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1 is a side view of a conveyable device disposed on a road surface that has undergone an asphalt surface treatment (AST) process according to some embodiments of the present invention.

FIG. 2 is top view of the device of FIG. 1.

FIG. 3 is a side view of a conveyable device disposed on a road surface that has undergone an AST treatment according to some other embodiments of the present invention.

FIG. 4 is a block diagram illustrating exemplary features of the devices of FIGS. 1-3 and external cooperating devices according to some embodiments of the present invention.

FIG. 5 is a flow chart illustrating exemplary operations according to some embodiments of the present invention.

FIG. 6 is an exploded schematic illustration of a brush and collection member of the devices of FIGS. 1-3.

FIG. 7 is an enlarged side view of the device of FIG. 1.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the expression “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

As used herein, the term “about” used in connection with a recited (e.g., claimed) value means +/−10% or +/−20% of the claimed value in various embodiments.

The present invention provides methods and apparatus for collection and weight measurement of material applied to a road surface on a bonding medium which may be removed and collected depending on the ability of the bonding agent to bond the material to the road surface. More specifically, embodiments of the present invention may be particularly suitable for use with material applied during an asphalt surface treatment (AST) process of road resurfacing. As known to those skilled in the art, several terms for AST exist, including chip seal, seal coat, surface treatment, bituminous surface treatment, sprayed seal (Austria) and surface dressing (United Kingdom).

As will be described below, some embodiments of the present invention are directed to an apparatus which sweeps a portion or section of the treated road and measures the loss of aggregate material before and/or after the brushing of the road (i.e., after the bond time and before traffic is allowed on the road). Such an apparatus and related methods may provide field practitioners a value that can be related to the strength of the bonding between tack coat and aggregate by providing a percent loss per unit area of road surface, for example. The percent loss allows a contractor, inspector or transportation department to evaluate the quality of the tack coat and/or modify parameters of application, cure time and/or bond time which can optimize the bonding and extend road surface life. This may also facilitate optimization of aggregate application to avoid an over-application resulting in increased cost of the road and unnecessary increased loss/waste of aggregates.

Generally summarized, according to some embodiments, apparatus and methods of the present invention employ a device having a rotating brush to collect loose aggregates or aggregates with a relatively weak bond from the road surface. The aggregate may be captured and weighed. The distance of the collection may be measured to calculate the area of the collection. In various embodiments, the device may be moved along the pavement surface automatically by mechanical features (e.g., drive mechanisms) independent of the operator or manually by the operator. The speed of the apparatus moving across the pavement may be monitored and used to control the rate of travel or used to provide a feedback mechanism signaling the user that the speed is too fast or too show. Alternatively, the device may automatically maintain a proper speed. Furthermore, ambient and/or surface temperature monitoring may be employed to monitor potential effects of surface and/or ambient temperatures to aggregate loss.

A conveyable device 10 according to some embodiments is illustrated in FIGS. 1 and 2. The device 10 may include a frame 12. A rotatable brush 14 is held at least partially by or within the frame 12. A collection member 16 is also held at least partially by or within the frame 12, with the collection member 16 typically adjacent the brush 14. The brush 14 may be round or generally round when viewed from the side and may be driven by a motor 18 or, in the case of an operator conveying the device, the brush may be driven by a mechanical drive mechanism linked to the rotation of the wheels as the device is conveyed. The motor 18 may be battery powered, fuel/gas powered or powered in any other way known to those of skill in the art. A gear and chain system, belt drive, direct drive system or other drive system known to those of skill in the art may be used to transfer power from the motor 18 to the brush 14. In the illustrated embodiment, a chain and gear drive system 19 is used to transfer power from the motor 18 to the brush 14. The rate of rotation of the brush 14 may be adjustable. The brush 14 may be configured to contact a roadway surface to collect loose aggregates or aggregates that are weakly or relatively weakly bound to a bonding material such as an adhesive or tack coat.

As shown in FIG. 1, the conveyable device 10 may be positioned on and conveyed over an existing road surface 20 that has undergone an AST treatment wherein a bonding layer or tack layer 22 is applied to the existing road surface 20 and an aggregate layer 24 is distributed over the bonding layer 22. The bonding layer 22 may be bituminous emulsion or asphalt cement, for example. The aggregate layer 24 may include finely graded aggregates (e.g., stone). As described above, during an asphalt surface treatment operation, a bonding medium is sprayed on or otherwise applied to the existing road surface 20 to form a tack coat. After a bond time, the road surface is swept and traffic is typically allowed on the road. The device 10 in FIG. 1 is shown on the chip-sealed road after the aggregate is distributed and rolled. The existing road surface 20, the bonding layer 22 and the aggregate layer 24 may be collectively referred to as the repaired road surface 25.

The conveyable device 10 may be manually operated, automatically operated (e.g., by a motor) and/or operated by remote control. As shown in FIG. 1, the device 10 may include a handle 26 such that a user may manually convey (e.g., push or pull) the device 10 over the repaired road surface 25.

As the device 10 travels over the surface 25, the rotating brush 14 urges the loose and weakly bound aggregates into the collection member 16. The brush 14 may be positioned in front or behind the collection member 16 (e.g., depending on the direction of rotation of the brush 14). In some embodiments, a first collection member is positioned in front of the brush 14 and a second collection member is positioned behind the brush 14. In some embodiments, a first brush is positioned in front of the collection member 16 and a second brush is positioned behind the collection member 16.

The collection member 16 may have a width W1 that extends at least a width W2 of the brush 14 (FIG. 2) and be of adequate size to collect aggregate from the brush 14. The collection member 16 is positioned adjacent to the brush 14 so that material is swept into the collection member 16 by the brush 14 through an opening 16o (FIG. 6) or otherwise in the collection member 16 that faces the brush 14. At least a portion of the collection member 16 may be angled downwardly so that a front edge 16f maintains contact with or is positioned closely spaced-apart to and adjacent the repaired road surface 25. The collection member 16 may be spring loaded to urge the front edge 16f toward or against the road surface 25. The collection member 16 may be constructed of or lined with a soft or shock absorbent material to prevent aggregate from bouncing back out of the collection member 16. Additionally or alternatively, the collection member 16 may have a geometry that helps to prevent aggregate from bouncing out of the collection member 16. For example, the collection member 16 may have an inverse-U or inverse-V profile/shape in a direction transverse the width W1, thereby forming a pocket or valley 16v in which the collected aggregate may be retained. Additionally or alternatively, the collection member 16 can attach to a bag or other container to collect the aggregate. In some embodiments, the collection member 16 is a collection tray.

Referring to FIG. 6, the collection member 16 may have an opening 16o facing the brush 14 and a bottom edge 16e that resides closely spaced to or abutting the road surface 25. In some embodiments, as shown in FIG. 7, the collection member 16 has an at least partially open top as indicated at 16t. As illustrated in FIG. 6, as the device 10 travels along the road surface 25 in the direction D, the brush 14 engages loose aggregates and/or aggregates that are weakly bound to a bonding medium and urges the engaged aggregates into the collection member 16, and, in various embodiments, generally in the same direction D, substantially in the same direction D, and in the same direction D.

Turning back to FIG. 1, a plurality of wheels 28 may be connected or mounted to the frame 12 to allow the device 10 to travel or be conveyed across the surface. The wheels 28 may be constructed of any suitable material. For example, the wheels 28 may comprise metal to allow ease of cleaning. The wheels 28 may be polymeric or rubber or have a rubber or polymeric outer layer to provide improved traction.

The brush 14, the motor 18 and/or the brush drive mechanism 19 may be connected or mounted in a carriage 30 that may be raised and lowered for maintenance and may be adjustable to raise or lower the brush against the road surface. The carriage 30 may be connected or mounted to the frame 12. For example, a pivot axle, member or rod 32 may pivotally connect the carriage 30 to opposite sides of the frame 12 such that the carriage 30 may be raised and lowered for maintenance and/or to adjust the force of the brush 14 against the road (or the spatial relationship between the brush 14 and the road).

The elevation or height of the brush 14 in relation to the wheels 28 and hence the road surface 25 may be adjusted via one or more brush height adjustment mechanisms 34, thereby adjusting the force of the brush 14 against the surface 25 (or the spatial relationship between the brush 14 and the road surface 25). In some embodiments, and as illustrated, the adjustment mechanism 34 includes a threaded member 36 with a knob 38 attached thereto for ease of turning the threaded member 36. There may be a scale or the like to indicate the height position (e.g., a gauge or similar height measurement feature on the frame 12 or the carriage 30). Machined, threaded blocks 40 and springs may be used to hold the brush in height position and/or make adjustment to the height by use of the knobs 38 and threaded members 36. The machined, threaded blocks 40 may be attached to the frame 12. In some embodiments, the threaded member 36 may be advanced into and retracted from the threaded block 40 to lower and raise the carriage 30 and therefore the brush 14. In some embodiments, the threaded blocks 40 may be rotated away from the carriage 30 to allow the carriage 30 to be rotated on the pivot member 32 for maintenance.

The device 10 can include a distance measurement system 42 (FIG. 2) to measure the distance that the device 10 conveys along the surface 25. For example, an encoder, odometer or other distance measurement device may be mounted to one or more of the wheels 28 or another portion of the device 10 to measure the distance traveled. The distance measurement system 42 may be activated manually or automatically upon movement of the device 10 (e.g., in an active “test” mode). Other distance measurement systems known to those of skill in the art may be employed. For example, an accelerometer may be mounted on device 10, such as on the frame 12 or carriage 30. The accelerometer may communicate with a controller C1 and/or C2 shown in FIG. 4 and described below, which may calculate the distance conveyed based on signals from the accelerometer. As another example, the device 10 may include a GPS receiver and a controller (e.g., controller C1 and/or C2) can communicate with the GPS receiver to measure and/or display the distance conveyed based on GPS signals.

The device 10 may have one or more speed indicators to provide visual and/or audible feedback to the operator that the device 10 is or is not being conveyed at a proper speed or within a proper speed range. For example, LED lights, a sound generating device and/or a speedometer may be provided on the device 10. The speed of the device 10 may be monitored in a number of ways. For example, an encoder, odometer, accelerometer, GPS receiver or other distance measurement system described above may be in communication with a controller (e.g., controller C1 and/or C2), which may calculate or determine the rate at which the device 10 is being conveyed.

A scale may optionally be incorporated in the device 10 to weigh collected aggregate. The scale may weigh the collected aggregate in the collection member 16 or may use a separate weighing container. As shown in FIG. 2, a scale S may be integrated with or disposed on or under at least a portion of the collection member 16. The scale S may automatically transfer the weight to a controller which may communicate with a display and/or communicate with memory to store weight information, as will be described in more detail below. Alternatively, the aggregate collection member or tray 16 may be removed from the device 10 and weight of aggregate obtained by an independent scale (e.g., a scale not attached to the device 10). The measured weight of the aggregate may be used for calculation of the aggregate loss per area of collection (e.g., per square feet).

At least one temperature sensor may be included with the device 10 to measure the ambient temperature and/or the temperature of the road surface. In some embodiments, and as illustrated in FIG. 1, a temperature sensor 44 may be disposed on a bottom portion of the frame 12 to measure the road surface temperature and a temperature sensor 46 may be disposed on a top portion of the frame 12 (or handle 26) to measure the ambient temperature. Of course, the sensor(s) 44, 46 may be mounted in any suitable location to measure the appropriate temperature. The sensor(s) may communicate with a controller for display and/or storage to memory, as described in more detail below.

As noted above, conveyable devices according to some embodiments may be automatically conveyed. The device 10′ shown in FIG. 3 is similar to the device 10 shown in FIGS. 1 and 2 and can include any of the features of the device 10. The device 10′ includes a drive motor 50 for automatically driving the device. That is, the drive motor 50 may be operatively connected to one or more of the wheels 28 or an axle associated therewith, for example via one or more belts or chains 52. The motor driven device 10′ may have a speed adjustment to attain the correct rate of travel or may be set such that only one specific rate of conveyance or travel is possible. The motor 50 of the device 10′ (as well as the motor 18) may be battery powered, fuel/gas powered or powered in any other way known to those of skill in the art. The motor used for conveying the device may also be used to rotate the brush 14 (i.e., one of the motors 18, 50 may be omitted). In some embodiments, the device 10′ includes an actuator such as a switch that an operator may actuate to begin or activate conveyance of the device 10′. The device 10′ may travel a predetermined distance (perhaps at a controlled speed) as determined by a distance measurement device and/or a controller, as described above. In some embodiments, the device 10′ may be operated by remote control, as described in more detail below.

Referring to FIG. 4, the devices 10 and 10′ may include at least one onboard controller C1. The controller C1 may be configured to receive signals from various components described above including the scale S (where used), the distance measurement device 42, the ambient temperature sensor 46, and the road surface temperature sensor 44. The controller C1 may be configured to store signals from these components in memory M1 and/or display values on a display D1. The controller C1 may be configured to determine the speed that the device 10, 10′ is being conveyed, for example using the distance measurement device 42 and a timer, and may be configured to store speed data in memory M1 and/or display speed data on display D1. As described above, the devices 10, 10′ may include components for audible or visual alerts when the vehicle is being conveyed at a speed that is too high, too low, or outside a predetermined range. The controller C1 may be configured to provide speed data to these components to activate the audible or visible alerts (an alert may also be provided on the display D1). The controller C1 may also be able to determine an amount of aggregate lost per unit area, for example using the weight from the scale S and the distance conveyed from the distance measurement device 42 (the width W1 of the collection member 16 and/or the width W2 of the brush 14 may also be used for this determination).

The devices 10, 10′ may also include a user input device U1. The user input device U1 may be configured to accept user input including commands to start or stop the drive motor 50 and/or the brush motor 18, for example. The user input device U1 may be in communication with the controller C1, which may provide signals to the various components. The user input device U1 may also be configured to accept input for requesting information to be displayed on the display D1 such as speed data, aggregate loss per unit area, etc. The user input device U1 may also be configured to receive user input such as ambient condition data (temperature, relative humidity, etc.) and the total amount/weight of aggregate applied during the AST process. This latter set of information may be used by the controller C1 to calculate the net loss of aggregate per unit area, for example. The user interface device U1 may be integrated with the display D1 (e.g., a touch sensitive display).

The devices 10, 10′ may also include a receiver Rx1 and a transmitter Tx1 (or a transceiver). The receiver Rx1 and a transmitter Tx1 may be configured to communicate with one or more external or outside devices 100. Although only one external device 100 is shown in FIG. 4, it will be understood that a plurality of external devices 100 may be employed to communicate with the device 10, 10′. The external device 100 may include a receiver Rx2 and a transmitter Tx2 to communicate with the transmitter Tx1 and the receiver Rx1, respectively, of the device 10, 10′. The device 10, 10′ and the external device 100 may communicate wirelessly, such as via RF signals, Bluetooth or any wireless communication known to those of skill in the art. The external device(s) 100 may be any suitable device such as a computer (e.g., a laptop, electronic notebook or tablet computer) or mobile portable terminal (e.g., a smartphone or a PDA) and/or remote server using the internet.

The external device 100 may communicate with the device 10, 10′ to provide commands to the device 10, 10′, to convey information to the device 10′, 10′ and/or to receive data or information from the device 10, 10′. For example, the external device 100 may command the device 10, 10′ to start the brush motor 18 and the drive motor 50, for example via user input device U2. The external device may instruct the device 10, 10′ to convey a desired distance (perhaps at a desired speed) over the road surface to collect aggregate, for example via user input device U2. The external device 100 may request or automatically receive certain data or information from the device 10, 10′, including ambient temperature, surface temperature, distance conveyed, speed conveyed, weight of aggregate collected, percent aggregate loss, and so forth. In some embodiments, the external device 100 receives information from the device 10, 10′, and a controller C2 determines certain values based on the received information. For example, the external device 100 may receive information from the distance measurement device 42, and the controller C2 may determine the distance the device 10, 10′ was conveyed and/or the speed at which the device 10, 10′ was conveyed. The controller C2 may also determine the percent loss of aggregate per unit area based on, for example, data received from the device 10, 10′ including data from the scale S and the distance measurement device 42. The external device 100 may store data and information in memory M2 and/or may display the data or information on display D2. The external device 100 may include or be in communication with a printer that may print test results or other information and/or a database for saving such information for user access.

A remote control R may also be provided. The remote control R may include a transmitter Tx3 that communicates with the receiver Rx1 of the device 10, 10′. The remote control R may be used to drive the device 10, 10′ back and forth to a field operator, drive the device 10, 10′ to its material collection test starting point and/or convey the device 10, 10′ over the road surface to collect aggregate, for example using user input device U3. The remote control R may be a handheld device with Bluetooth, such as a smartphone, electronic notebook/pad, portable computer, or PDA, or a RF transmitter or an IR transmitter capable of sending remote signals to control different operations of the device 10, 10′. It will be appreciated that the external device 100 may be used instead of or in combination with the remote control R to perform at least some of these functions.

Therefore, according to some embodiments, with automated or semi-automated operation, the device 10, 10′ may be placed on a road surface and either remotely or manually started. The device 10, 10′ may automatically start the brush rotation and drive wheel(s) activation. The device may travel a predetermined distance, measured by the distance measurement device (e.g., wheel encoder), stop the brush and drive motor and may automatically weigh the collected material and calculate the amount of material collected per unit area. The data may be stored in the electronic system for future download to an external device by remote or wired means, to a printer and/or displayed for the operator. The distance of travel may be selected by the user, may be fixed, or may be determined by the weight of the collected material in the collection tray.

Turning now to FIG. 5, exemplary operations according to embodiments of the invention are illustrated. A method 100 for testing the adequacy of a bond between a bonding medium and an aggregate applied thereon by an AST operation (e.g., a chip seal operation) on a road surface includes conveying a device a distance over the road surface (Block 102). Loose and/or weakly bound aggregate is collected in the device as the device is conveyed over the road surface (Block 104). The aggregate collected in the device is weighed (Block 106). A loss of aggregate based on the weight of the aggregate collected in the device is determined (e.g., electronically determined) (Block 108). In some embodiments, the distance that the device is conveyed over the road surface is measured (e.g., electronically measured) (Block 110). A percent loss of aggregate per unit area may be determined (e.g., electronically determined) based on the weight of the aggregate collected in the device and the measured distance that the device is conveyed over the road surface (Block 112). It will be appreciated that these operations may be carried out using the devices and components described above. It will also be appreciated that additional operations are contemplated, including those described above in connection with the described devices and components.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

That which is claimed is:

1. A post-road surface maintenance field test device, comprising:
a frame;
a plurality of wheels connected to the frame;
a rotatable brush held at least partially by or within the frame;
a drive mechanism configured to rotate the brush; and
a collection member held at least partially by or within the frame, the collection member residing adjacent the rotatable brush;
wherein, in operation, as the device is conveyed over a road surface, the drive mechanism rotates the brush and the brush engages loose aggregates and/or aggregates that are weakly bound to a bonding medium and urges the engaged aggregates into the collection member.

2. The device of claim 1, further comprising a speed detection mechanism and at least one indicator and/or alarm to provide audible and/or visual feedback to the user that the device is being conveyed at a proper speed and/or within a proper speed range.

3. The device of claim 1, further comprising or in communication with a distance measurement device configured to measure a distance that the device is conveyed over the road surface.

4. The device of claim 1, further comprising a handle connected to the frame, the handle adapted for a user to manually convey the device over the road surface.

5. The device of claim 1, further comprising a drive mechanism operatively connected to the wheels to automatically convey the device over the road surface.

6. The device of claim 1, further comprising at least one of an ambient temperature sensor to detect an ambient temperature or a road surface temperature sensor to detect a road surface temperature.

7. The device of claim 1, further comprising a scale integrated with or in communication with the collection member, the scale configured to weigh the aggregate collected in the collection member.

8. The device of claim 1, wherein the collection member has an opening facing the brush and a bottom edge that resides closely spaced to or abutting the road surface.

9. The device of claim 1, wherein the device includes a controller and at least one of a display, a memory and a user input device, wherein the controller is configured to communicate with the display and/or the memory to display on the display and/or store in the memory at least one of the following: cure time, bond time, total weight of aggregate, weight of aggregate collected, ambient temperature, road surface temperature, the distance conveyed over the road surface, the speed at which the device is conveyed and the percent loss of the aggregate per unit area.

10. The device of claim 1, further comprising a receiver configured to receive signals from an external device and/or a remote control, including at least one of the following:
a command to start or stop the drive mechanism associated with the wheels and/or the drive mechanism associated with the brush;
a command to convey the device over the road surface; and
a request for data including at least one of cure time, bond time, total weight of aggregate, weight of aggregate collected, ambient temperature, road surface temperature, the distance conveyed over the road surface, the speed at which the device is conveyed and the percent loss of the aggregate per unit area.

11. The device of claim 1, further comprising a transmitter configured to transmit signals to an external device such that at least one of the following can be displayed and/or storied in data at the external device: cure time, bond time, total weight of aggregate, weight of aggregate collected, ambient temperature, road surface temperature, the distance conveyed over the road surface, the speed at which the device is conveyed and the percent loss of the aggregate per unit area.

12. A method for testing the adequacy of a bond between a bonding medium and an aggregate applied thereon by a maintenance operation on a road surface, the method comprising:
conveying a device a distance over the road surface;
collecting loose and/or weakly bound aggregate in the device as the device is conveyed over the road surface;
weighing the aggregate collected in the device; and
electronically determining a loss of aggregate based on the weight of the aggregate collected in the device.

13. The method of claim 12, comprising:
electronically measuring the distance that the device is conveyed over the road surface; and
electronically determining a percent loss of aggregate per unit area based on the weight of the aggregate collected in the device and the measured distance that the device is conveyed over the road surface.

14. The method of claim 12, wherein the device comprises a frame, a rotatable brush at least partially held within the frame, and a collection member held within the frame adjacent the rotatable brush, and wherein collecting loose and/or weakly bound aggregate in the device as the device is conveyed over the road surface comprises:
rotating the brush; and
urging the aggregate into the collection member using the rotating brush.

15. The method of claim 14, wherein the device includes a scale integrated with or in communication with the collection member, the method comprising weighing the aggregate collected in the device using the scale.

16. The method of claim 14, wherein the collection member is removable from the frame, the method comprising:
removing the collection member with the collected aggregate therein; and
weighing the collected aggregate with or without the collection member.

17. The method of claim 12, comprising automatically, manually or remotely conveying the device a distance over the road surface.

18. The method of claim 12, comprising measuring at least one of a surface temperature and an ambient temperature as the device is conveyed over the road surface.

19. The method of claim 12, comprising measuring at least one of: a cure time indicating the time between application of the bonding medium on the road surface and application of the aggregate on the bonding medium during the road surface maintenance operation; a total weight of the aggregate applied on the bonding medium; and a bond time indicating a time between application of the aggregate on the bonding medium and a determination that the maintenance operation is deemed to be complete.

20. The method of claim 12, comprising electronically storing in memory at least one of the distance the device is conveyed over the road surface, the weight of the aggregate collected in the device, the percent loss of aggregate per unit area, the surface temperature, the ambient temperature, the cure time, the total weight of aggregate and the bond time.

21. The method of claim 12, wherein the device includes a transmitter, the method comprising transmitting at least one of the following to at least one external device using the transmitter: the distance the device is conveyed over the road surface, the weight of the aggregate collected in the device, the percent loss of aggregate per unit area, the surface temperature, the ambient temperature, the cure time, the total weight of aggregate and the bond time.
